(19) United States
(12) Patent Application Publication
(10) Pub. No.: US 2025/0109506 A1
(43) Pub. Date: Apr. 3, 2025

(54) SYSTEMS AND METHODS FOR PRODUCING CLEAN HYDROGEN FOR WATER RECLAMATION

(71) Applicant: micone, inc., Fallbrook, CA (US)

(72) Inventors: Robert Plaisted, Santa Clarita, CA (US); Michael Evans, San Juan Capistrano, CA (US)

(73) Assignee: micone, inc., Fallbrook, CA (US)

(21) Appl. No.: 18/904,056

(22) Filed: Oct. 1, 2024

Related U.S. Application Data
(60) Provisional application No. 63/587,264, filed on Oct. 2, 2023.

(51) Int. Cl. C25B 1/04; C25B 9/23; H01M 8/0656

(52) U.S. Cl. CPC C25B 1/04; C25B 9/23; H01M 8/0656

(57) ABSTRACT

A system for generating hydrogen includes a chamber configured to receive a fluid, and a first end plate and a second end plate configured to be positioned within the chamber and defining a longitudinal axis between first end plates. The system further includes a plurality of plates positioned between the first end plate and the second end plate, configured to be submerged in the fluid, and including: a cathode plate, an anode plate, and a semi-permeable membrane plate positioned between the cathode plate and the anode plate and configured to allow the passage of some elements therethrough and to block the passage of other elements therethrough. The system further includes at least one plasma source configured to be positioned within the fluid on an axial end of the plurality of plates and configured to generate a directed flow of plasma through the chamber along the axis.

### CROSS-REFERENCE TO RELATED APPLICATIONS

This application is a non-provisional U.S. patent application which claims the benefit and priority of U.S. Provisional Application No. 63/587,264, titled Systems and Methods for Producing Clean Hydrogen and filed on Oct. 2, 2023, the entire contents of which being hereby incorporated by reference in its entirety.

### BACKGROUND

### 1. Field

The present disclosure relates to systems and methods for producing at least one of clean hydrogen, e.g., for use as a fuel, or clean water, e.g., for water reclamation.

### 2. Description of the Related Art

Human civilization continues to advance technologically. Among other advantages, this advancement helps accommodate a continuing rise in human population, for example, by developing new means of powering our civilization and means for increasing resource availability (such as food, water, and shelter). Humans consume large quantities of power in our daily lives (e.g., driving to work and back, powering our homes and equipment, etc.) and, in addition, availability of power is a requirement for most future advancements (e.g., artificial intelligence algorithms utilize large quantities of power during learning and use). Power is frequently generated by burning a fuel (e.g., coal, oil, and gas) which drives a turbine or generator which in turn creates electricity, or which drives an engine to create torque.

There has been a recent push to reduce carbon emissions in our environment. Burning conventional fuels such as coal, oil, and gas expels carbon and other emissions into the environment, potentially harming the environment for all of its residents. There have been advancements towards use of alternative fuels which expel less carbon and other emissions into the environment; these alternative fuels may include electricity (especially if generated using wind power or solar power), biogas, hydrogen, or the like. Hydrogen is an especially interesting alternative fuel because it can be used in a fuel cell to generate power and only expels water as an emission. However, extraction and creation of hydrogen is relatively difficult and complex, thus making hydrogen an expensive fuel to use. It would thus be desirable to develop a way to generate clean hydrogen relatively inexpensively.

In another aspect, human beings and our civilization require a significant amount of water to survive and thrive. Water is used in everything from drinking water (required for human life) to industrial processes (e.g., water cooling is used in many industries) and farming (crops and livestock both require significant amounts of water). While earth has vast stores of clean water, much of that water is inaccessible (i.e., in difficult to reach locations, frozen in ice caps, etc.) or salt water (and thus unusable in its present state). Humans generate a relatively large amount of wastewater (e.g., from some water-cooled systems, from shower drains, etc.) that is relatively expensive to clean for reuse (known as water reclamation). It would thus be desirable to find means for reverting wastewater back into usable water.

Accordingly, there is a need in the art for systems and methods for generation of clean hydrogen and for water reclamation.

### SUMMARY

Described herein is a system for generating hydrogen. The system includes a chamber configured to receive a fluid. The system further includes a first end plate and a second end plate configured to be positioned within the chamber and defining a longitudinal axis from the first end plate to the second end plate. The system further includes a plurality of plates positioned between the first end plate and the second end plate, configured to be submerged in the fluid, and including: a cathode plate, an anode plate, and a semi-permeable membrane plate positioned between the cathode plate and the anode plate and configured to allow the passage of some elements therethrough and to block the passage of other elements therethrough. The system further includes at least one plasma source configured to be positioned within the fluid on an axial end of the plurality of plates and configured to generate a directed flow of plasma through the chamber along the axis.

Also described is a plate assembly. The plate assembly includes a first end plate and a second end plate each configured to be positioned within a chamber and defining a longitudinal axis from the first end plate to the second end plate. The plate assembly further includes a plurality of plates positioned between the first end plate and the second end plate, configured to be submerged in a fluid within the chamber, and including: a plurality of cathode plates, a plurality of anode plates, and a plurality of semi-permeable membrane plates positioned between the cathode plate and the anode plate and configured to allow the passage of some elements therethrough and to block the passage of other elements therethrough, the plurality of anode plates and the plurality of cathode plates being positioned in an alternating repeating pattern with one of the plurality of semi-permeable membrane plates being positioned between each anode plate and each cathode plate.

Also described is a system for generating hydrogen. The system includes a chamber configured to receive a fluid. The system further includes a first end plate and a second end plate configured to be positioned within the chamber and defining a longitudinal axis from the first end plate to the second end plate. The system further includes a plurality of plates positioned between the first end plate and the second end plate, configured to be submerged in the fluid, and including: a plurality of cathode plates, a plurality of anode plates positioned in an alternating fashion with the plurality of cathode plates, and a plurality of semi-permeable membrane plates each positioned between one of the cathode plates and one of the anode plates and configured to allow the passage of some elements therethrough and to block the passage of other elements therethrough, such that each plate is spaced apart from adjacent plates. The system further includes at least one plasma source configured to be positioned within the fluid on an axial end of the plurality of plates and configured to generate a directed flow of plasma through the chamber along the axis.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a block diagram illustrating a system for production of hydrogen using electrolysis, according to various embodiments of the present disclosure;

FIG. 2 is a block diagram illustrating a plate assembly configured for use in the system of FIG. 1, according to various embodiments of the present disclosure;

FIG. 3 is a diagram illustrating an exemplary plate from the plate assembly of FIG. 2, according to various embodiments of the present disclosure;

FIG. 4 is a drawing of a portion of a system for production of hydrogen using electrolysis and having an outer shell, a tank, and a top cap, according to various embodiments of the present disclosure;

FIG. 5 is a drawing of the system of FIG. 4 having a lid with a frame and panels, according to various embodiments of the present disclosure;

FIG. 6 is a block diagram illustrating a system for production of hydrogen using electrolysis, according to various embodiments of the present disclosure;

FIG. 7 is a drawing showing fittings and busbars used in a system for production of hydrogen using electrolysis, according to various embodiments of the present disclosure; and

FIG. 8 is a block diagram illustrating a system for water reclamation using plate assemblies, according to various embodiments of the present disclosure.

### DETAILED DESCRIPTION

The present disclosure describes systems and methods for facilitating an electrolysis reaction. For example, the systems and methods may facilitate hydrolysis (electrolysis of water) to produce hydrogen (and oxygen as a byproduct). In some embodiments, the systems and methods disclosed herein may also facilitate electrolysis of alterative compounds to produce various products (e.g., the systems and methods may facilitate electrolysis of hydrocarbons into light aromatic hydrocarbons such as isobutane, may facilitate the creation of graphene or titanium dioxide, or the like.) The systems and methods disclosed herein provide several benefits and advantages over conventional methods of hydrogen production. The systems and methods disclosed herein may advantageously produce “clean,” or “green,” hydrogen meaning that no carbon emissions are generated during the production of the hydrogen, thus advantageously reducing greenhouse gas emissions from the production of hydrogen. The systems and methods advantageously utilize plasma to induce free electrons to increase hydrogen output: the plasma forms a hydroxyl radical (:OH) and a superoxide anion (O2-), and the associated ion-impact and electron-impact decomposition of water molecules results in additional hydrogen. The systems and methods also provide the benefit of reduced energy use by the system by utilizing a pulsed input power signal rather than a continuous direct current (DC) or alternating current (AC) input power signal, thus reducing a cost per unit hydrogen that is produced by the system.

An exemplary system includes a chamber designed to contain water and additional system elements. The system further includes a plurality of plates positioned within the chamber, the plates including two end plates with cathode plates and anode plates therebetween, along with membrane plates positioned between each end plate, cathode plate, and anode plate. The system further includes a plasma source designed to generate and input plasma into the system and towards the plurality of plates. The system also includes a power source designed to provide pulsed DC power to the plasma torch, thus causing the plasma torch to output pulses of DC plasma towards the plates. The system further includes a fluid source designed to provide a fluid, such as water, into the system to be used in electrolysis to generate hydrogen and oxygen. The system also includes an outlet through which hydrogen generated by the system may exit the chamber and be collected for later use.

In operation, the thermal decomposition of water and the plasma field of energy strips electrons from hydrogen atoms at a relatively high voltage bias, leaving free electrons and hydrogen protons, along with other components such as radical OH molecules. A pulsed bias from the plasma source attracts electrons to the plates and creates a condition that is similar to a supercapacitor. A secondary bias is applied between the plasma bias plates. This secondary bias has a relatively small current flow and a reduced voltage relative to the plasma such that the combination of the plasma voltage and the secondary bias results in the decomposition of water at a reduced energy level compared to conventional electrolysis.

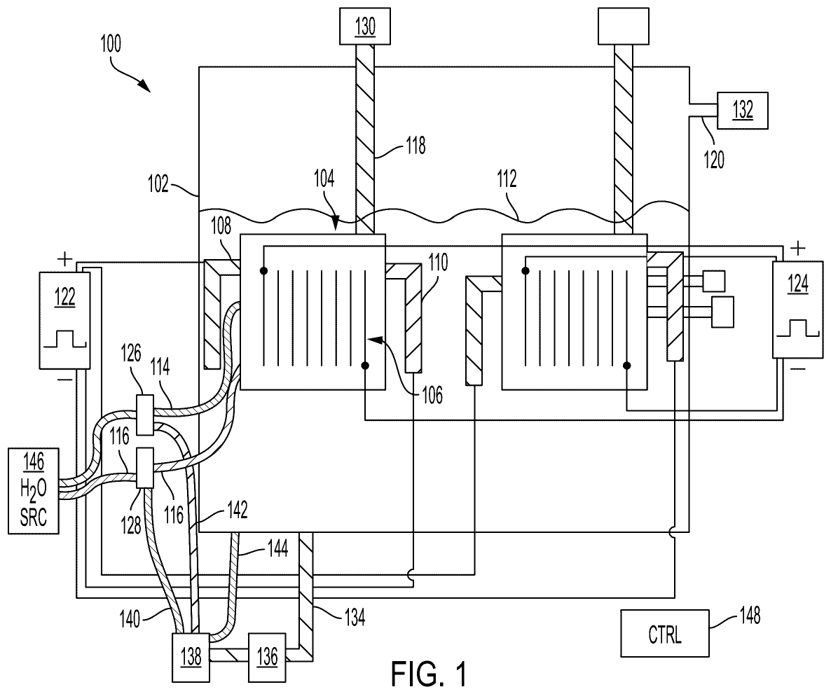

Referring now to FIG. 1, an exemplary system 100 is shown. The system 100 may include a chamber 102, which may be defined by a vessel or container. The chamber 102 is designed to hold components of the system 100 and to contain a fluid 112, such as water. The system 100 may further include one or more plate assembly 104 which includes a plurality of plates 106. If more than one plate assembly 104 is included, the multiple plate assemblies 104 may be positioned within the chamber 102 in any configuration. For example, the plate assemblies 104 may be positioned end-to-end as shown in FIG. 1 (i.e., the plate assemblies 104 may be oriented in series). In some embodiments, the plate assemblies 104 may be positioned in any other configuration (i.e., in parallel, or any other configuration). Any quantity of plate assemblies 104 may be included in the system 100.

The system 100 may also include a plasma source 108 designed to generate a flow of plasma towards the plurality of plates 106. In some embodiments, the system 100 may include a second plasma source 110 designed to generate a flow of plasma towards the plurality of plates 106, such as from an opposite end of the plurality of plates than the first plasma source 108. In such embodiments, the plasma source 108 may have a positive bias and the plasma source 110 may have a negative bias. In some embodiments, only the first plasma source 108 may be present, and it may have a positive bias or a negative bias. In some embodiments, the system 100 may include at least one plate plasma source 108 for each plate assembly 104. In that regard, each plate assembly 104 and its respective plasma source(s) 108 may function as a separate unit.

As indicated above, the chamber 102 may contain a fluid 112. In some embodiments, each of the plurality of plates 106 may be submerged below a top surface of the fluid 112 within the chamber 102 (i.e., the plates 106 may be surrounded by the fluid 112). The fluid 112 may include water (H₂O). In some embodiments, the water may be demineralized. In some embodiments, the fluid 112 may include an electrolyte-based fluid. For example, the electrolyte-based fluid may include demineralized water with potassium hydroxide (KOH) added thereto. In some embodiments, the fluid 112 may include any additional or alternative fluid capable of facilitating electrolysis within the system 100.

As will be discussed in more detail below, the plurality of plates 106 may include at least one cathode plate and at least one anode plate. The system 100 may include an anode fluid source 114 designed to provide a fluid to the one or more anode plate, and a cathode fluid source 116 designed to provide a fluid to the one or more cathode plate. The fluid from the anode fluid source 114 may be fluidly isolated from cathode plates of the plates 106, and the fluid from the cathode fluid source 116 may be fluidly isolated from anode plates of the plates 106. The fluid may include the same fluid 112 as that located within the chamber 102 or may include a different fluid. In some embodiments, the fluid provided to the anode plates may be different than the fluid provided to the cathode plates. In some embodiments, the same fluid may be provided to the anode plates and the cathode plates. In some embodiments, the fluid 112 within the chamber 102 may be fluid that has previously been provided to one or more of the plurality of plates 106. That is, fluid may be provided to one or more of the plates 106 to facilitate the electrolysis process, and the leftover fluid that was originally provided to the plates 106 may flow into the chamber 102.

The system 100 may also include a hydrogen outlet 118 designed to port the hydrogen generated by the system 100 to a location outside of the chamber 102 for storage or use. For example, a component of the system 100 may separate the hydrogen and oxygen produced by the system 100 such that the hydrogen outlet 118 receives the hydrogen and ports the hydrogen to an external component for storage or use. Any known method of separating hydrogen from oxygen may be used for this separation of hydrogen from oxygen. In a similar manner, an oxygen outlet 120 may be designed to port the oxygen generated by the system 100 to a location out side of the chamber 102 for storage, for use, or for expulsion as a waste product. In some embodiments, the system 100 may only include a single gas outlet that ports a mixture of hydrogen and oxygen generated by the system 100 to a location outside of the system, such that a separate system or component may separate the hydrogen from the oxygen.

The system 100 may include one or more power source configured to provide electrical power to one or more component of the system to facilitate the electrolysis process. For example, the system 100 may include a first power source 122 designed to generate or output electrical power for use by components of the system 100. The first power source 122 may be coupled to the plasma source 108 (e.g., a positive bias from the first power source 122 may be coupled to the plasma source 108) and used by the plasma source 108 to generate charged plasma. In some embodiments, the first power source 122 may also be coupled to the second plasma source 110 (e.g., a negative bias from the first power source 122 may be coupled to the second plasma source 110). In some embodiments, the system may lack a second plasma source. The power from the first power source 122 may be used by the plasma source 108 (and potentially the plasma source 110) to generate plasma used by the system 100.

In some embodiments, the system 100 may also include a second power source 124. The second power source 124 may also be designed to generate or output electrical power for use by components of the system 100. In some embodiments, the second power source 124 may be coupled to one or more of the plates 106. For example, a positive terminal of the second power source 124 may be coupled to one or more of the plates 106. In some embodiments, a negative terminal of the second power source 124 may also be coupled to another one or more of the plates (which may be different than the plates coupled to the positive terminal of the second power source 124). In some embodiments, the second power source 124 may be designed to output a power signal having a reduced amplitude relative to the power signal output by the first power source 122. Stated differently, the first power source 122 may output a stronger power signal than the second power source 124.

In some embodiments, one or both of the first power source 122 and the second power source 124 may be designed to output an alternating current (AC) power signal, a direct current (DC) power signal, or both. In some designs, the power sources 122, 124 may be designed to output a pulsed DC power signal (e.g., the power sources 122, 124 may include transistors or other switches which may function as a pulse generator). For example, the power signal output by the first power source 122 may have a voltage of between 1 volt and 1,000 volts, between 100 volts and 700 volts, between 200 volts and 400 volts, or the like. The power signal output by the first power source 122 may have a frequency of between 0 hertz (Hz) and 100 megahertz (MHz), between 0 Hz and 10 MHz, or the like. The power signal output by the first power source 122 may have a duty cycle that is between 0 and 1, that is between 0.25 and 0.75, or the like.

In a similar manner, the power signal output by the second power source 124 may have a voltage of between 1 volt and 1,000 volts, between 100 volts and 700 volts, between 200 volts and 400 volts, or the like. The power signal output by the second power source 124 may have a frequency of between 0 Hz and 100 MHz, between 0 Hz and 10 MHz, or the like. The power signal output by the first power source 122 may have a duty cycle that is between 0 and 1, that is between 0.25 and 0.75, or the like. In some embodiments, the frequency and duty cycle of the power signal output by the second power source 124 may match the frequency and duty cycle of the power signal output by the first power source 124. In some embodiments, the frequency and duty cycle of the power signal output by the second power source 124 may be different than the frequency and duty cycle of the power signal output by the first power source 122. In some embodiments, the frequency and duty cycle of the power signal output by the second power source may be different than, but related to (e.g., a multiple of) the frequency and duty cycle of the power signal output by the first power source 122. In some embodiments, the amplitude of the power signal output by the second power source 124 may be less than the amplitude of the power signal output by the first power source 122.

The system 100 may include one or more pump utilized to direct fluids through the system 100 as desired. Where used herein, a pump may refer to any component usable to direct fluids through components of the system 100 using any one or more of gravity, suction, pressure, or the like. In some embodiments, a pump may also or instead include a valve or other fluid control equipment.

In some embodiments, a pump 126 may be coupled to the anode fluid source 114 and may pump fluid towards anode plates of the plurality of plates 106. Similarly, a pump 128 may be coupled to the cathode fluid source 116 and may pump fluid towards cathode plates of the plurality of plates 106. In some embodiments, at least one of the pump 126 or the pump 128 may be coupled to one or more fluid source or reservoir 146 such that fluid pumped by the pumps 126, 128 is drawn from the fluid source or reservoir 146. In some embodiments, the pump 126 may be coupled to a different fluid source or reservoir than the pump 128 is coupled to.

In some embodiments, a pump 130 may be coupled to the hydrogen output port 118. In that regard, the pump 130 may force or draw hydrogen generated by the system 100 towards a hydrogen reservoir, vessel, or other component. Similarly, a pump 132 may be coupled to the oxygen output port 120. The pump 132 may force or draw oxygen (as well as any potential byproducts) generated by the system 100 towards an oxygen reservoir, vessel, or other component, or towards an environment of the system 100 (e.g., to mix with air). In some embodiments, a single pump may be used to draw a mixture of hydrogen and oxygen from the chamber 102 towards a reservoir, vessel, or other component and the separation of hydrogen from oxygen may occur outside of the system 100, or by a component of the system 100 positioned outside of, or separated from, the chamber 102.

In some embodiments, the system 100 may include a fluid outlet 134 in fluid communication with the fluid 112 in the chamber 102, a heat exchanger 138, and a pump 136 in fluid communication with the fluid outlet 134. The pump 136 may draw fluid from the chamber 102 via the fluid outlet 134 towards the heat exchanger 138, and the heat exchanger 138 may use ambient air or another fluid to reduce a temperature of the fluid 112 within the chamber. The cooled fluid from the heat exchanger 138 may be ported back into the chamber 102 using a fluid inlet 144. In some embodiments, it may be desirable to increase a temperature of the fluid 112. In that regard, the heat exchanger 138 may be designed to increase a temperature of the fluid 112. In some embodiments, the heat exchanger 138 may be designed to both increase and decrease a temperature of the fluid 112 to cause the temperature to remain within a predetermined temperature range.

In some embodiments, the predetermined temperature range may be greater than an ambient air temperature. For example, it may be desirable for the fluid 112 to be between 160 degrees Fahrenheit and 170 degrees Fahrenheit for maximum efficiency. Thus, upon startup, the fluid 112 may have a temperature that is less than the predetermined temperature range. In some embodiments, the system 100 may also include a probe or other device (not shown) that at least partially extends into the fluid 112 and is designed to increase a temperature of the fluid 112. Upon startup, the probe or other device may speed up the increase in temperature of the fluid 112, thus causing the system 100 to operate more efficiency quicker than without the probe or other device that accelerates the heating process.

In some embodiments, the system 100 may include a cathode fluid port 140 and an anode fluid port 142, both in fluid communication with the heat exchanger 138. In that regard, the fluid with the regulated temperature may be ported towards the cathode fluid source 116 via the cathode fluid port 140 to be provided to the cathodes plates of the plates 106. Similarly, the fluid with the regulated temperature may be ported towards the anode fluid source 114 via the anode fluid port 142 to be provided to the anode plates of the plates 106.

In some embodiments, the system 100 may include or be coupled to a fluid source 146. The fluid source 146 may provide or store a fluid utilized in the electrolysis process performed by the system 100. For example, the fluid source 146 may provide demineralized water, or a mixture of demineralized water and potassium hydroxide (KOH) added thereto. The fluid source 146 may be in fluid communication with the pump 126 coupled to the anode fluid source 114 and the pump 128 couped to the cathode fluid source 116 such that fluid from the fluid source 146 may be provided to the anode plates and the cathode plates via the pump 126 and the pump 128, respectively.

In some embodiments, the fluid source 146 may provide or store two or more compounds (e.g., demineralized water and KOH). In that regard, the fluid source 146 may include one or more elements used to mix the two compounds together. For example, a mixture of demineralized water and KOH having specific properties may provide optimal results. In that regard, the element(s) of the fluid source 146 may combine the two or more compounds to generate a mixture having the specific properties before providing the mixture to the pumps 126, 128.

In some embodiments, fluid from the fluid source 146 may also be provided directly into the chamber 102 without being provided to the anode plates or cathode plates. For example, it may be desirable for a specific volume of fluid 112 to be positioned in the chamber 102. In that regard, a sensor may be positioned in the chamber 102 and designed to detect data corresponding to a volume of the fluid (e.g., a fluid level within the chamber 102), and a pump may operate in tandem with the pump 136 to increase and decrease the volume of fluid in the chamber based on the desired volume of fluid.

In some embodiments, the system 100 may include a controller 148. The controller 148 may include one or more logic device such as a controller, processor, discrete logic device, or the like capable of performing logic functions. The controller 148 may also include a non-transitory memory designed to store data usable by the logic device to perform predetermined functions (e.g., computer programs) and additional data as requested by the logic device (e.g., a desired level of fluid in the chamber 102).

The controller 148 may be coupled to adjustable components of the system 100 (e.g., the power sources 122, 124, any sensors, and all pumps) and be designed to control operation of the adjustable components based on desired parameters of the system. For example, the controller 148 may control the pump 136 and the heat exchanger 138 based on a detected temperature of the fluid 112 in order to cause the fluid to remain within a desired temperature range.

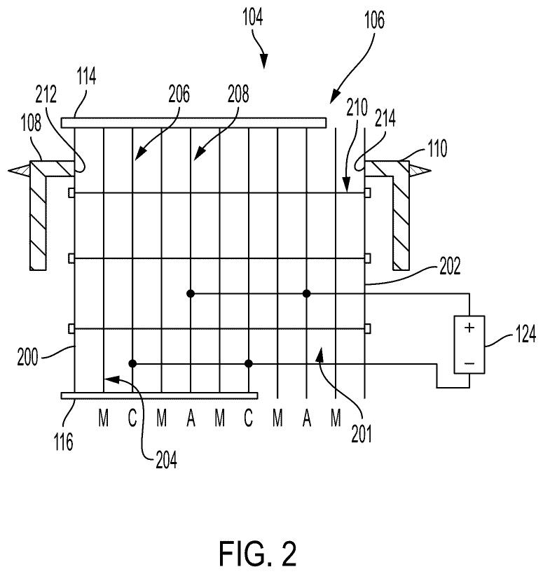

Turning now to FIG. 2, additional details of an exemplary plate assembly 104 is shown. The plate assembly 104 may be used in the system of FIG. 1 alone or with additional plate assemblies 104. As mentioned above, the plate assembly 104 may include a plurality of plates 106 including a first end plate 200, a second end plate 202, a plurality of membrane plates 204, a plurality of cathode plates 206, and a plurality of anode plates 208. In some embodiments, the plate assembly 104 may include one or more fastener 210 to retain various components of the plate assembly 104 in their respective locations.

The end plates 200, 202 may be positioned at axial ends of the plate assembly 104 and may define apertures 212, 214 for receiving a portion of the plasma sources 108, 110, respectively. That is, a portion of the plasma source 108 may be positioned within the aperture 212 and oriented in such a way so as to direct the flow of plasma towards the remaining plates of the plate assembly 104. In some embodiments, the end plates 200, 202 may define a chamber 201 therebetween. In some embodiments, additional features may be included to further define the chamber 201 (e.g., plates oriented perpendicular to the plates 106 may be positioned on edges of the plate assembly 104 to extend between the end plates 200, 202, seals positioned along edges of the plates 106, or the like).

The chamber 201 may be sealed or unsealed between the end plates 200, 202 (as well as any additional features such as seals). In sealed configurations, fluid within the system 100 may not be capable of entering or exiting the chamber 201 apart from designed ingress and egress points (e.g., defined inlets and outlets such as the anode fluid source 114 and the cathode fluid source 116). For example, fluid may enter the plate assembly 104 via the anode fluid source 114 and the cathode fluid source 116, and may only exit the plate assembly 104 via designed outlets. In some embodiments, fluid may be incapable of passing between multiple plates (e.g., fluid that enters between two plates 106 via the anode fluid source 114 may be incapable of flowing to another location between a different two plates). In some embodiments, fluid may flow freely within the plate assembly 104 (and between the chamber 201 and locations not within the plate assembly 104).

In some embodiments, a membrane plate 204 may be positioned between each of the remaining types of plates 106 in the plate assembly 104. For example and as shown in FIG. 2, a first membrane plate 204 may be positioned between the end plate 200 and a first cathode plate 206, a second membrane plate 204 may be positioned between the first cathode plate 206 and a first anode plate 208, and another membrane plate 204 may be positioned between the first anode plate 208 and a second cathode plate 206. In some embodiments, a membrane plate 204 may not be placed adjacent to the end plates 200, 202 such that the end plates 200, 202 are positioned adjacent to one of a cathode plate 206 or an anode plate 208.

In some embodiments, the cathode and anode plates 206, 208 may be positioned in an alternating fashion (e.g., one anode plate 208 may be positioned between each cathode plate 206, and one cathode plate 206 may be positioned between each anode plate 208). The plate assembly 204 may include any quantity of plates so long as a membrane plate 204 is positioned between each cathode plate 206 and each anode plate 208.

In some embodiments, the plates 200, 202, 204, 206, 208 may be spaced apart from each other by a distance. For example, the distance may be between 0.01 inches and 5 inches, between 0.1 inches and 1 inch, or about 0.5 inches. In some embodiments, at least a portion of each plate 200, 202, 204, 206, 208 may be in contact with at least a portion of an adjacent plate 200, 202, 204, 206, 208. In some embodiments, the distance between at least some adjacent plates may be the same between each plate of the plate assembly 104, or the distance between each adjacent plate may be the same or similar (e.g., within 10 percent of the distance between other adjacent plates).

In some embodiments, the power source 124 (having a lower power output than the power source 122 of FIG. 1) may be coupled to the cathode plates 206 and the anode plates 208. For example, one of the positive terminal or the negative terminal of the power source 124 may be coupled to the cathode plates 206, and the other of the positive terminal or the negative terminal of the power source may be coupled to the anode plates 208. In that regard, various biases may be applied to the cathode plates 206 and the anode plates 208.

In some embodiments, each of the plates 106 in the plate assembly 104 may be coupled together. For example, this coupling may be achieved using fasteners 210 (e.g., screws, snap-fit connectors, brackets, or the like), using an adhesive (e.g., a fluid-resistant adhesive such as an epoxy), an interference fit between the components, or the like. In embodiments in which fasteners 210 are used, each of the plates 106 may define one or more aperture that align when the plates 106 are positioned in their respective locations, and the fastener 210 may extend through the apertures and be held in plate using nuts and bolts or the like. In some embodiments, seals may be positioned between each adjacent plate 106 such that fastening the plates 106 together using the fasteners 210 forms a seal between the seal of each respective plate.

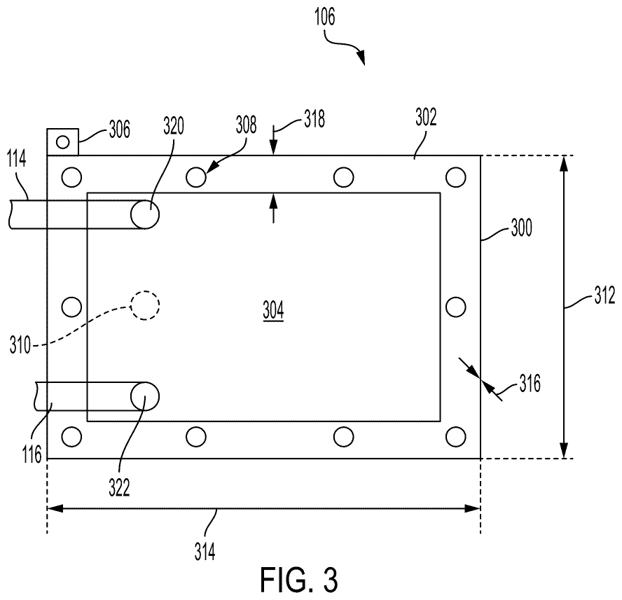

Turning now to FIG. 3, an exemplary plate 300 is shown. The plate 300 may represent any of the plates 106 of FIG. 1 or 2. Each of the plates 300 may have a similar design, size, and configuration. For example, each of the plates 300 may have a cuboid or rectangular prism shape (although any other shape may be utilized without departing from the scope of the present disclosure). The plates 300 may include an inner surface 304 and an outer 302 positioned along a perimeter of planar surfaces of the plate 300.

Each of the plates 300 may include a tab 306 coupled thereto. In some embodiments, the tab 306 may be in electronic communication with the power source 124 of FIGS. 1 and 2. In that regard, the tab 306 of the cathode plates may be coupled to the positive terminal or the negative terminal of the power source 124, and the tab 306 of the anode plates may be coupled to the other of the positive terminal or the negative terminal of the power source 124. In some embodiments, a cable coupled to one of the positive terminal or the negative terminal may be positioned through an aperture defined by the tab 306 and be electrically isolated from the tab 306 if the specific terminal is not to be coupled to the respective plate 300. For example, an insulator of the cable may insulate the cable from the tab 306 for the cathode plates, and the cable may be electrically coupled to the tab 306 for the anode plates.

The outer edge 302 of the plates 300 may define a plurality of fastener apertures 308 around the circumference of the plate 300. In that regard, the fasteners 210 of FIG. 2 may extend through the fastener apertures 308 of the plates 300 to retain the plates 300 in place relative to each other. In some embodiments, the outer edge 302 may include an insulator to reduce the likelihood of electrical currents flowing between plates via the fastener 210 and the fastener apertures 308 of the respective plates 300.

The end plates 200, 202 may define or include one or more plasma aperture 310. The plasma aperture 310 may be designed to receive the plasma source 108 of FIG. 1 such that the plasma from the plasma source 108 may enter the plate assembly 104 of FIG. 1 via the plasma aperture 310. In some embodiments, a seal may be positioned between the plasma source 108 and the surface of the end plate 300 to reduce the likelihood of plasma flowing out of the chamber 201 of FIG. 2 via a gap between the plasma source 108 and the end plate 300.

The end plates 200, 202 may further define or include one or more fluid aperture or fluid port 320, 322. The fluid apertures or ports 320, 322 may be designed to be coupled to one or more fluid source or fluid drain to allow fluid communication between one or more location in the plate assembly 104 and the one or more fluid source or fluid drain. In that regard, the fluid apertures or ports 320, 322 may port at least a portion of fluid from the fluid source to another location in the system 100, may port at least a portion of the fluid to a fluid drain, or the like. For example, the fluid aperture or port 320 may be coupled to the anode fluid source 114 and may port the fluid from the anode fluid source 114 to the anode plates 208, and the fluid aperture or port 322 may be coupled to the cathode fluid source 116 and may port the fluid from the cathode fluid source 116 to the cathode plates 206. In some embodiments, seals may be present between the fluid sources 114, 116 and the end plate 300 to reduce the likelihood of fluid loss by the system 100.

The plates 300 may have a first dimension 312 (e.g., a width), a second dimension 314 (e.g., a length), and a third dimension 316 (e.g., a thickness). In some embodiments, the first dimension 312 may be between 5 inches and 40 inches, between 10 inches and 34 inches, or about 22 inches. Where used in this context, “about” refers to the referenced value plus or minus 10 percent of the referenced value. In some embodiments, the second dimension 314 may be between 5 inches and 40 inches, between 10 inches and 34 inches, or about 24 inches. In some embodiments, the second dimension 314 may be greater than the first dimension 312. In some embodiments, the third dimension 316 may be between 0.01 inches and 2 inches, 0.1 inches and 1 inch, or about 0.25 inches. The outer edge 302 of the plates may have an edge width 318 between the edge of the plate 300 and the inner surface 304 of the plate. In some embodiments, the edge width 318 may be between 0.1 inches and 5 inches, between 0.5 inches and 2 inches, or about 1 inch.

In some embodiments, the third dimension 316 of the plates 300 may be greater at the outer edge 302 than at the inner surface 304. In that regard, the distance between adjacent plates at the outer edge 302 may be less than the distance between adjacent plates at the inner surface 304. In some embodiments, the outer edge 302 of at least some of the plates may be in contact with the outer edge 302 of adjacent plates and the inner surface 304 of the adjacent plates 300 may be spaced apart, as a result of the greater third dimension 316 at the outer edge relative to the inner surface 304. In some embodiments, the third dimension 316 may be the same or substantially the same at the outer edge 302 and the inner surface 304.

Referring now to FIGS. 1-3, the membrane plates 204 (e.g., the inner surface 304 thereof) may be semi-permeable (i.e., some atoms may flow therethrough and the passage of other atoms therethrough may be blocked). For example, the outer edge 302 of the membrane plates 204 may include a metal, plastic, or other rigid material, and the inner surface 304 of the membrane plates 204 may include a semi-permeable membrane. The outer edge 302 of the membrane plates 204 may retain the inner surface 304 (which may include a semi-permeable membrane) in place within a plane defined by the outer edge 302. The membrane (i.e., inner surface 304) of the membrane plates 204 may include a solid sheet of material or a mesh (e.g., a patterned network of wire, thread, or other fine elongated portions of material).

In some embodiments, the membrane of the membrane plates 204 may include an anion exchange membrane or a proton exchange membrane. In some embodiments, the membrane of the membrane plates may include at least one of a titanium-based membrane, a graphene-based membrane, a nickel-based membrane, a stainless steel-based membrane, a polytetrafluoroethylene (PTFE)-based membrane, or a polymeric plastic-based membrane, an Ethylene acrylic elastomer-based membrane, or a polymer electrolyte-based membrane.

In some embodiments, the end plates 200, 202 may include any material such as a plastic, a metal, a wood, a ceramic, a glass, a textile, a leather, a paper, a polymer, a rubber, an epoxy, or any other material. In some embodiments, the inner surface 304 of the end plates 200, 202 may be an insulator, a conductor, or semiconductor. In some embodiments, the end plates 200, 202 may reflect electrical signals, protons, electrons, plasma, or the like such that the chamber 201 defined therebetween may function as a resonance chamber to reflect signals or plasma back towards the cathode plates 206 and the anode plates 208 to increase a quantity of power in the chamber 201. In some embodiments, any additional components that form the chamber 201 may assist in forming the resonance chamber.

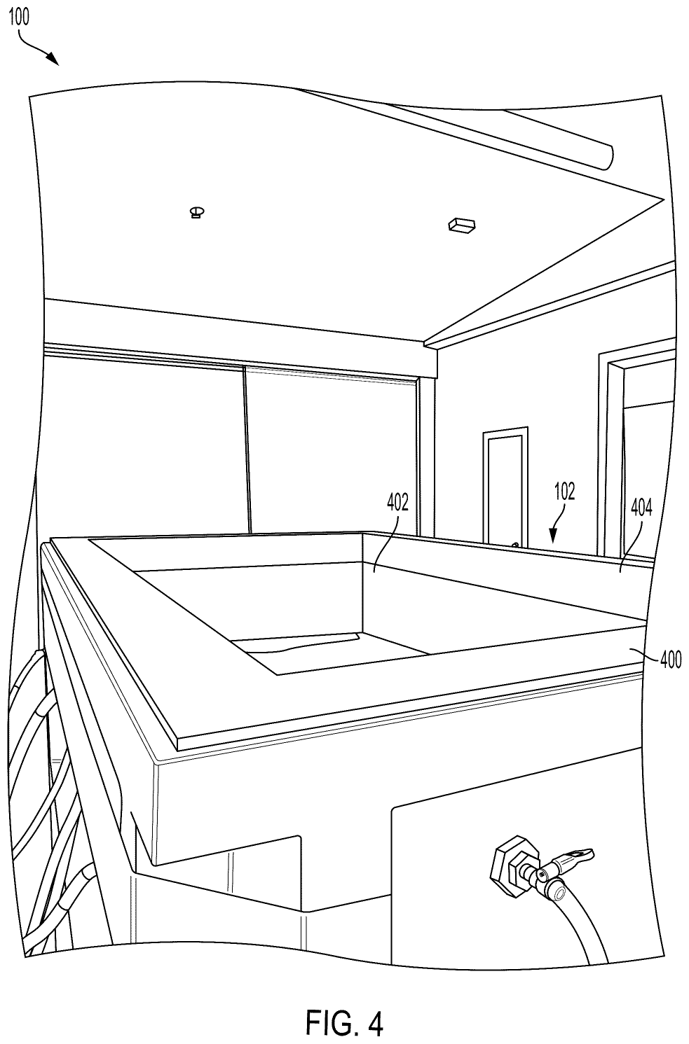

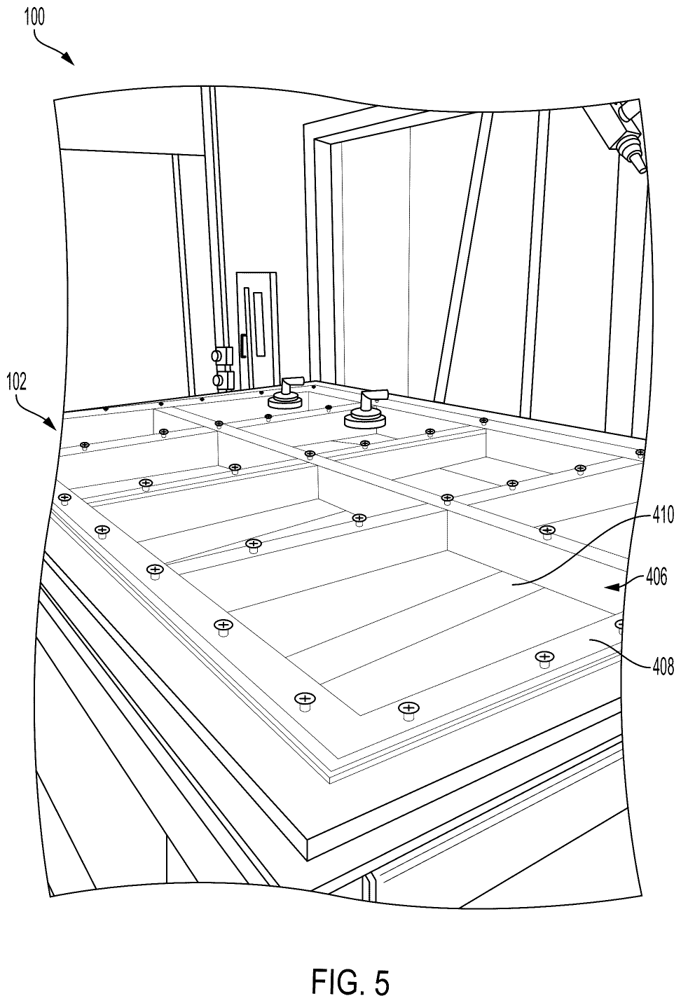

Turning now to FIGS. 4 and 5, additional features of the system 100 are shown. In particular, the system 100 may include a top cap 404 and a lid 406 coupled to the chamber 102. The chamber 102 may include a tank 402 in which fluid is held, and an outer shell 400 in which the tank 402 is retained. The tank 402 may include, for example, polyethylene or any other material that fails to react with other components of the system 100. The outer shell 400 may include, for example, stainless steel or another material that is sufficient to retain components of the chamber 102 therein. The top cap 404 may be welded to a frame located between the tank 402 and the outer shell 400, and the top cap 404 may encapsulate the tank 402 to the outer shell 400. The top cap 404 may be polished to a flat surface in some embodiments.

The lid 406 may rest on the top cap 404 and may enclose the components of the chamber 102 within the lid 406 and the tank 402. The lid 406 may include a frame 408 which may include reinforced metal as well as panels 410. In some embodiments, the panels 410 may include acrylic, Lexan, or another clear material to allow viewing within the chamber 102. In some embodiments, the panels 410 of the lid 406 may be hinged with dampeners and latches. In that regard, all power and gas connections may be located through a side of the chamber 102, rather than through the lid 406.

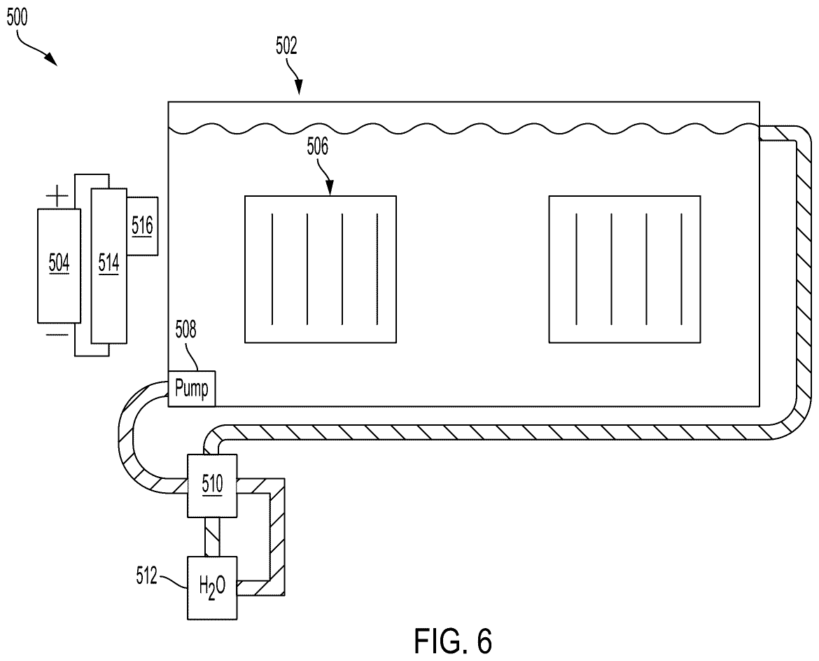

Turning to FIG. 6, another exemplary system 500 is shown. The system may include similar features and components as the system 100 of FIG. 1, however, only certain features and components are shown in FIG. 6. The system 500 may include a chamber 502 in which one or more plate assembly 506 may be located. The system 500 may also include a power source 504 that provides power to a plasma source (not shown). The system 500 may include one or more rectifier 514 (e.g., a 3-phase bridge rectifier) coupled between the power source 504 and the plasma source to rectify a power signal provided by the power source. The system 500 may further include a cooling device 516, such as a heat sink with cooling fans, to cool the rectifier 514. Any other cooling device 516 may be used, such as a heat exchanger.

As with the system 100, the system 500 may include a heat exchanger 510 used to cool the fluid (e.g., de-ionized water) in the chamber 502. A pump 508, such as a circulating pump, may draw fluid from near a bottom of the chamber 502 of one end of the chamber 502 and may port the fluid through the heat exchanger 510. The pump 508 may be located outside of the chamber 502 (i.e., may be an external pump) and may access the fluid in the chamber 502 via a port or other opening through the wall of the chamber 502 (e.g., a hose or tube may extend through an opening through the wall of the chamber and be in fluid communication with the pump 508). In some embodiments, the pump 508 may be located within the chamber 502 and may pump fluid through a port in the chamber wall in communication with the heat exchanger 510. The fluid from the pump 508 may be cooled in the heat exchanger 510 and returned to near a top of the chamber 502 on an opposite end of the chamber 502 from the pump 508. In some embodiments, the pump 508 and return port for the cooled fluid may be located in any other location of the system 500. A fluid source 512 may provide a loop of cooling fluid (e.g., water) usable to cool the fluid from the pump 508.

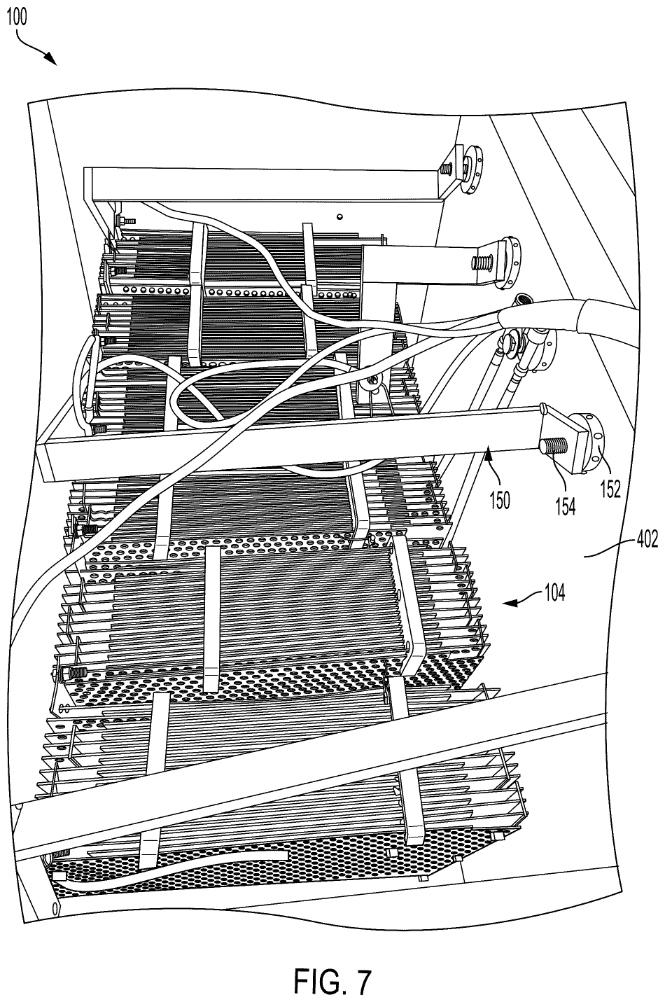

Turning to FIGS. 1 and 7, fittings 152 may be coupled to an internal surface of the tank 402. The fittings 152 may have an electrical coupling 154 to the second power source 124. The system 100 may further include busbars 150 that electrically couple the electrical coupling 154 to the plate assemblies 104. The busbars 150 may be formed to have a shape that extends from the fittings 152 to an appropriate connection to a respective plate assembly 104 or respective plate assemblies 104. The busbars 150 may include any conductive material, such as stainless steel, and may include any shape or size capable of porting an appropriate amount of electrical power. For example, the busbars 150 may have a cross-sectional dimension of 0.5 inches by 2 inches.

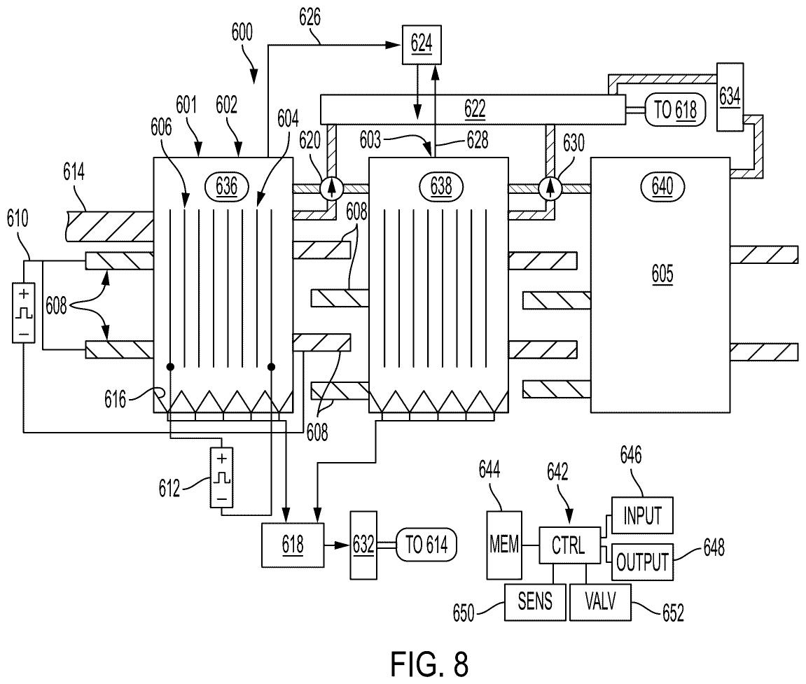

Referring to FIG. 8, a system 600 may include similar features as the system 100 of FIG. 1 and may function in a similar manner and be based on the same scientific principles; however, the system 600 may be optimized for use in water reclamation instead of hydrogen generation. In particular, the system 600 may include a plurality of cells 602, or plate stages 602, that each include a plate assembly 604 having a plurality of plates 606. Each plate assembly 604 may include two end plates with a plurality of anode plates and cathode plates positioned in an alternating fashion between the two end plates, with a semi-permeable membrane plate positioned between each anode plate and cathode plate. In that regard, the features and functions of the plate assembly 604 (including the plates and their respective designs) may be similar to the features and functions of the plate assembly 104 of the system 100 of FIG. 1 (including the plates and their respective designs as well as the membrane plates).

Each cell 602 of the system 600 may include a plate assembly such as the plate assembly 604. A system 600 may include any quantity of cells 602 therein. As shown in FIG. 8, the exemplary system 600 includes a first cell 601 and a second cell 603 that each include a plate assembly 604 having end plates, anode plates, cathode plates, and semi-permeable membrane plates between the anode plates and cathode plates. The end plates, anode plates, cathode plates, and semi-permeable membrane plates may have a similar design as, and function in a similar manner as, the respective plates 106 of FIG. 1. As will be further discussed below, the system 600 may further include a sterilization stage 605 that sterilizes any remaining particles in treated water that reaches the sterilization stage 605.

As with the system 100 of FIG. 1, the system 600 may include a plurality of plasma sources 608. The plasma sources 608 may be designed to generate a directed flow of plasma through each of the cells 602 and the sterilization stage 605. For example, each cell 602 may include one, two, three, or more plasma sources 608 that direct a directed flow of plasma through the respective cell 602 (e.g., from a first end plate to a second end plate). Each plasma source may include an emitter located on a first longitudinal end of a respective cell 602 and a collector located on a second longitudinal end of the respective cell 602, which is opposite the first longitudinal end. In that regard, each cell 602 includes two plasma sources 608 such that each cell 602 includes two plasma emitters and two plasma collectors.

The system 600 may further include a first power source 610 and a second power source 612. In some embodiments, the first power source 610 may generate or output a greater quantity of power (e.g., more watts than) the second power source 612 and may be designed to provide electrical power to the plasma sources 608. In that regard, each of the plasma sources 608 may receive power from the power source 610 and may convert the electrical power into plasma that flows through the respective cell 602. The first power source 610 thus functions in a similar manner as the first power source 122 of FIG. 1. For example, a positive terminal of the first power source 610 may be coupled to the emitter (or collector) of each plasma source 608, and a negative terminal of the first power source 610 may be coupled to the collector (or emitter) of each plasma source 608.

The second power source 612 may also generate or output electrical power. The second power source 612, as with the second power source 124 of FIG. 1, may be coupled to, and provide electrical power to, one or more of the plates 606. For example, a positive terminal of the second power source 612 may be coupled to one or more of the plates, and a negative terminal of the second power source 612 may be coupled to another one or more of the plates. In some embodiments, the positive terminal of the second power source 612 may be coupled to each of the cathode plates (or anode plates), and the negative terminal of the second power source 612 may be coupled to each of the anode plates (or cathode plates). In that regard, the cathode plates and anode plates may be biased using power from the second power source 612.

In some embodiments, one or both of the first power source 610 and the second power source 612 may be designed to output an alternating current (AC) power signal, a direct current (DC) power signal, or both. In some designs, the power sources 122, 124 may be designed to output a pulsed DC power signal (e.g., the power sources 122, 124 may include transistors or other switches which may function as a pulse generator). For example, the power signal output by the first power source 610 may have a voltage of between 1 volt and 1,000 volts, between 100 volts and 700 volts, between 200 volts and 400 volts, or the like. The power signal output by the first power source 610 may have a frequency of between 0 hertz (Hz) and 100 megahertz (MHz), between 0 Hz and 10 MHz, or the like. The power signal output by the first power source 610 may have a duty cycle that is between 0 and 1, that is between 0.25 and 0.75, or the like.

In a similar manner, the power signal output by the second power source 612 may have a voltage of between 1 volt and 1,000 volts, between 100 volts and 700 volts, between 200 volts and 400 volts, or the like. The power signal output by the second power source 612 may have a frequency of between 0 Hz and 100 MHz, between 0 Hz and 10 MHz, or the like. The power signal output by the first power source 610 may have a duty cycle that is between 0 and 1, that is between 0.25 and 0.75, or the like. In some embodiments, the frequency and duty cycle of the power signal output by the second power source 612 may match the frequency and duty cycle of the power signal output by the first power source 610. In some embodiments, the frequency and duty cycle of the power signal output by the second power source 612 may be different than the frequency and duty cycle of the power signal output by the first power source 610. In some embodiments, the frequency and duty cycle of the power signal output by the second power source 612 may be different than, but related to (e.g., a multiple of) the frequency and duty cycle of the power signal output by the first power source 610. In some embodiments, the amplitude of the power signal output by the second power source 612 may be less than the amplitude of the power signal output by the first power source 610.

The system 600 may be designed to receive “dirty” water for water reclamation. “Dirty water” may refer to water that is unsuitable for certain purposes due to contaminants in the water. For example, “dirty water” may include sewage water, water that has irrigated farms, river water, or any other water that includes contaminants of any type. The system 600 may include a water source 614 that provides dirty water to the system 600. For example, the water source 614 may include a sewer, a pond, lake, or other surface body of water, a pipe through which dirty water is pumped, or any other water source 614 that stores or transports dirty water. Water from the water source 614 may be provided to the first cell 601.

In operation, the first cell 601 may be filled with dirty water from the water source 614. That is, dirty water may flow into the first cell 601 via the water source 614. In some embodiments, the first cell 601 may be filled entirely with dirty water; in some embodiments, the first cell 601 may receive enough water to entirely submerge each of the plates 606; in some embodiments, the first cell 601 may receive enough water to partially submerge each of the plates 606. The dirty water provided to the first cell 601 may not flow out of the first cell 601 until treated. That is, the dirty water in the first cell 601 may flow into the first cell 601 and may not have an outlet until after treatment.

Once the first cell 601 is filled with dirty water, the plate assembly 604, the plasma source 608, the first power source 610, and the second power source 612 may operate (i.e., the second power source 612 may bias the plates 606 and the first power source 610 may power the plasma source 608 to cause the plasma source 608 to generate plasma). With the plates 606 biased and the plasma source 608 directing plasma through the dirty water in the cell 601, electrolysis of the dirty water may occur, causing certain particles to precipitate from the dirty water and fall downward (i.e., towards a center of the earth from the cell 601) due to gravity and the density of the precipitates being greater than the density of water. A significant portion of contaminants in the water may precipitate out of the water and fall towards a bottom of the cell 601.

A manifold 616 may be located along a bottom end of the first cell 601. The manifold 616 may include elongated ridges and troughs such that precipitate is received in at least one of the troughs of the manifold 616. A component (e.g., a door, a vacuum, actuator, pump, or the like) may physically remove the precipitate from the troughs of the manifold 616. The physical removal of the precipitate may occur during the electrolysis or after the electrolysis is completed. The precipitate may be removed as a slurry with the precipitate mixed with some water. The slurry removed from the first cell 601 may be directed to, and stored in, a chamber 618. That is, the chamber 618 may store a slurry removed from the first cell 601 that includes precipitate mixed with water (e.g., dirty water with extra contaminants than the water received by the water source 614). The system 600 may include a pump that pumps the slurry from the chamber 618 through a filter 632. The filter may include any type of filter that can remove solid contaminants from the dirty water in the chamber 618. For example, the filter 632 may include activated charcoal, a sediment-type filter, or any other type of filter. After filtering the dirty water, the filtered water may be provided to at least one of the water source 614 (e.g., for additional treatment by the first cell 601) or the second cell 603 for treatment by the second cell 603.

After electrolysis by the first cell 601 is completed, a valve 620 at an outlet of the first cell 601 may adjust positions to direct the water into the second cell 603, back into the first cell 601, or into a holding tank 622. In some embodiments, any other feature in addition to, or instead of, the valve 620 may be used to port the treated water. In some embodiments, a set route may be present for the water from the first stage 601 (e.g., all water may be ported to the second cell 603 or the third cell 605, all water may be ported to the holding tank, the water may be ported to the chamber 618, or the like). For water ported back into the first cell 601, the electrolysis by the first cell 601 may occur again to further decontaminate the cleaned water.

The second cell 603 may have similar features and connections as the first cell 601. In some embodiments, the second cell 603 may be identical to the first cell 601 and treat water identically to the first cell 601. In some embodiments, the second cell 603 may have identical components to the first cell 601 but may operate using different values (e.g., a greater or lesser amount of plasma may be output by the plasma sources 608 of the second cell, the plates 606 of the second cell may be biased to a different voltage, or the like). In some embodiments, the second cell 603 may have similar components that have different values as the first cell 601 (e.g., the plates 606 may be of a different size, the second cell 603 may include greater or fewer plates 606, the second cell may include greater or fewer plasma sources, or the like). Water received by the second cell 603 (e.g., via the valve 620) may be subjected to electrolysis by the components of the second cell 603. That is, the water may be retained in the second cell 603 while the plasma sources 608 may generate plasma and the plates 606 are biased, thus subjecting the water to additional electrolysis to cause additional contaminants to precipitate from the water. The second cell 603 may have a similar manifold 616 as the first cell that includes similar features for removing a precipitate-heavy slurry from the bottom of the second cell 603, and the removed slurry may be provided to the chamber 618 or a similar chamber for treatment by a filter 632 to remove solidified particles. The filtered slurry (i.e., with fewer precipitated contaminants) may then be returned to the first cell 601, the second cell 603, the third cell 605, or the holding tank 622.

A second valve 630 may be positioned downstream from the second cell 603 and may cause the water to remain in the second cell 603 for treatment. After treatment of the water, the second valve 630 may port the treated water to its next location. For example, the second valve 630 may direct the treated water back into the second cell 603, may direct the treated water back into the first cell 601, may direct the treated water to the holding tank 622, or may direct the treated water to the third cell 605. In some embodiments, any additional or alternative components may be used in place of the second valve 630 to control the flow of water out of the second cell 603.

The third cell 605 may have different features than the first cell 601 or the second cell 603. Namely, the third cell 605 may lack any plate assemblies 604 or plates 606. The third stage 605 may include one or more plasma source 608 positioned to cause a flow of plasma across the third stage 605. In some embodiments, the plasma through the third stage 605 may create ultraviolet (UV) light having a frequency that sterilizes microorganisms and contaminants that remain in the treated water (e.g., UV-C light having a wavelength of between 240 nanometers (nm) and 285 nm, between 250 nm and 275 nm, between 260 nm and 265 nm, or the like). In some embodiments, additional or alternative components may be used in the third stage 605 to create UV light (e.g., LEDs or other light sources). In some embodiments, the third stage 605 may have a different shape than the first or second stages 601, 603. For example, the third stage 605 may have a tubular shape with a light source positioned circumferentially about the tube such that all fluid flowing through the third stage 605 is exposed to the UV-C light for a predetermined period of time. The UV light to which the water is exposed in the third stage 605 may kill or sterilize any remaining organisms such as parasites, bacteria, viruses, or the like. In some embodiments, the water may be controlled to remain in the third stage 605 for a predetermined period of time. In some embodiments, the water through the third stage 605 may have a predetermined flow rate that causes all of the water to be exposed to the UV light for a sufficient amount of time to kill at least a portion of the organisms (e.g., at least 90 percent of the organisms, at least 95 percent of the organisms, at least 99 percent of the organisms, at least 99.9 percent of the organisms, at least 99.99 percent of the organisms, or the like).

A filter 634 may be positioned downstream from the third stage 605 (i.e., between the third stage 605 and the holding tank 622) and may be designed to remove destroyed organisms (i.e., those sterilized by the third stage 605) and any other remaining particulates from the flow of water to the holding tank 622. For example, the filter 634 may include an activated charcoal filter, a sediment-type filter, or any other filter designed to remove items from the water. For example, the filter 634 may be designed to catch contaminants having a size (e.g., diameter) of at least 1 micrometer (1 micron), of at least 0.5 micron, of at least 0.1 micron, of at least 0.01 micron, or the like. The filtered and treated water from the filter 634 may be provided to the holding tank 622 for at least one of aeration or use.

In some embodiments, the system 600 may include an aerating pump 624 designed to aerate the water in the holding tank 622 (or at any additional or alternative location). This aeration may serve any of a number of purposes such as: providing oxygen to bacteria to accelerate digestion by the bacteria; reducing the concentration of volatile organic compounds; removing dissolved gases such as hydrogen sulfide, radon, or the like; oxidizing dissolved iron and manganese; or the like. In conventional water reclamation systems, the gases for an aeration step may be provided in the form of a tank with compressed gas (e.g., oxygen). However, the electrolysis reaction that occurs in the first cell 601 and the second cell 603 may result in formation of oxygen and hydrogen gases. A first gas line 626 may port at least a portion of the gases from the first cell 601 to the aeration pump 624, and a second gas line 628 may port at least a portion of the gases from the second cell 603 to the aeration pump 624. In some embodiments, the gases formed by the reaction in the cells 602 may be treated after removal from the cells 602 for any of a variety of reasons (e.g., to isolate oxygen gas from the hydrogen, to filter any particles from the gases, or the like). In some embodiments, the aeration pump 624 may be unnecessary; for example, the pressure of the gases formed in the cells 602 may be sufficiently great that the pressure forces the gases through the gas lines 626, 628 and into the holding tank 622 for aeration.

The system 600 may be controlled manually, electronically, or any combination thereof. In particular, a controller 642 may receive data from one or more sensor 650 positioned throughout the system 600 and may make decisions regarding operation of the system 600 based on an analysis of the sensor data (or based on input received from an operator). The controller 642 may include one or more logic device such as a controller, processor, discrete logic device, or the like capable of performing logic functions. The controller 642 may also include a non-transitory memory (at least one of located on board the controller 642 or a separate memory 644) designed to store data usable by the logic device to perform predetermined functions (e.g., computer programs) and additional data as requested by the logic device. That is, the memory 644 may be non-transitory and may store instructions usable by the controller 642 to control the system 600 and may store data as requested by the controller 642 (i.e., a history of control decisions).

The controller 642 may be coupled to adjustable components of the system 100 (e.g., the power sources 610, 612, any sensors 650, all valves 652, the aeration pump 624, one or more of the plasma sources 608, or the like) and be designed to control operation of the adjustable components based on desired parameters of the system. For example, the controller 642 may control the valves 652 (including at least one of the valve 620 or the valve 630) based on a quantity of particulates detected in one or more of the cells 602. In some embodiments, each cell; 602 may include one or more sensor including a first sensor 636 in the first cell 601, a second sensor 638 in the second cell 603, and a third sensor 640 in the third cell 605. The sensors 636, 638, 640 may include any one or more sensor designed to detect data corresponding to at least one of water quality, dynamic fluid processes, pump performance, ancillary system operations, or the like. For example, these sensors 636, 638, 640 (or any other sensor positioned at any location within the system 600) may include any one or more of a pH sensor, an oxidation-reduction potential (ORP) sensor, a turbidity sensor, a total suspended solids (TSS) sensor, a dissolved oxygen (DO) sensor, a chemical oxygen demand (COD) sensor, a biological oxygen demand (BOD) sensor, an ultraviolet (UV) detection sensors, a substance detection sensor, a level sensor, a pressure sensor, a temperature sensor, a flow meter, a motor voltage sensor, a motor current sensor, a motor temperature sensor, a vibration sensor, a leakage sensor, a current transducer, a load balancing diagnostic sensor, a capacitor sensor, a power conditioning sensor, a connected circuit breaker, a fuel level sensor, an annunciator panel sensor, a battery voltage sensor, an automatic transfer switch sensor, a hydrogen sulfide sensor, an emergency gas scrubber sensor, or the like. The data from all of these sensors may be received by the controller 642 for analysis by the controller 642, for output by the controller 642 for an operator to view, or the like.

The system 600 may further include an input device 646 and an output device 648. The input device 646 may include any input device such as a mouse, a keyboard, a touchscreen, a microphone, or the like that is capable of receiving user input. The user input may correspond to automatic control of the system 600, operator-based control of the system, or the like. The controller 642 may perform various functions based on the received input. The output device 648 may include any output device such as a display, a touchscreen, a speaker, or the like. The output device 648 may output any data to an operator such as sensor values, any alerts or warnings, current operation values of the system 600, or the like.

Where used throughout the specification and the claims, “at least one of A or B” includes “A” only, “B” only, or “A and B.” Furthermore, “at least one of A and B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A system for generating hydrogen, the system comprising:
a chamber configured to receive a fluid;
a first end plate and a second end plate configured to be positioned within the chamber and defining a longitudinal axis from the first end plate to the second end plate;
a plurality of plates positioned between the first end plate and the second end plate, configured to be submerged in the fluid, and including:
a cathode plate,
an anode plate, and
a semi-permeable membrane plate positioned between the cathode plate and the anode plate and configured to allow the passage of some elements therethrough and to block the passage of other elements therethrough; and
at least one plasma source configured to be positioned within the fluid on an axial end of the plurality of plates and configured to generate a directed flow of plasma through the chamber along the axis.

2. The system of claim 1, wherein the plasma source is configured to generate a pulsed flow of plasma.

3. The system of claim 2, wherein the pulsed flow of plasma produces hydrogen ions from the fluid.

4. The system of claim 2, wherein the plasma source is configured to be powered by a pulsed direct current (DC) signal having a voltage of between 200 volts and 400 volts and a frequency of between 1 hertz and 10 Megahertz.

5. The system of claim 1, wherein the semi-permeable membrane plate includes at least one of an anion exchange membrane or a proton exchange membrane.

6. The system of claim 1, wherein the semi-permeable membrane plate includes at least one of a titanium-based membrane, a graphene-based membrane, a nickel-based membrane, a stainless steel-based membrane, a polytetrafluoroethylene (PTFE)-based membrane, or a polymeric plastic-based membrane, an Ethylene acrylic elastomer-based membrane, or a polymer electrolyte-based membrane.

7. The system of claim 6, wherein the semi-permeable membrane plate includes at least one of a solid-sheet membrane or a mesh membrane.

8. The system of claim 1, wherein:
the cathode plate includes a plurality of cathode plates positioned between the first end plate and the second end plate;
the anode plate includes a plurality of anode plates positioned between the first end plate and the second end plate;
the semi-permeable membrane plate includes a plurality of semi-permeable membrane plates positioned between the first end plate and the second end plate; and
the plurality of anode plates and the plurality of cathode plates alternate in a repeating pattern with one of the plurality of semi-permeable membrane plates positioned between each anode plate and each cathode plate.

9. The system of claim 8, further comprising a first fluid source configured to provide the fluid to the plurality of anode plates, and a second fluid source configured to provide the fluid to the plurality of cathode plates, wherein the first fluid source is fluidly isolated from the plurality of cathode plates and the second fluid source is fluidly isolated from the plurality of anode plates.

10. The system of claim 8, wherein each of the plurality of plates is spaced apart from each adjacent plate by a distance.

11. The system of claim 8, wherein:
the first end plate, the second end plate, the plurality of plates, and the at least one plasma source together are a first plate assembly;
the system is configured to include at least a second plate assembly having similar components as the first plate assembly; and
the first plate assembly and the at least the second plate assembly are both configured to be positioned within the chamber and submerged in the fluid.

12. The system of claim 1, wherein the fluid includes at least one of water or an electrolyte-based fluid.

13. The system of claim 1, further comprising a plurality of fasteners configured to retain the plurality of plates in a fixed position relative to each other.

14. The system of claim 1, further comprising a second plasma source, wherein the first end plate defines an opening for receiving an outlet of the first plasma source and the second end plate defines an opening for receiving an outlet of the second plasma source.

15. The system of claim 14, wherein the first end plate and the second end plate define a resonance chamber therebetween.

16. The system of claim 1, further comprising an outlet configured to output the hydrogen generated by the system.

17. The system of claim 1, further comprising a second power source electrically coupled to at least some of the plurality of plates and having a voltage that is less than a voltage of the flow of the plasma.

18. The system of claim 1, further comprising a heat exchanger and a pump in fluid communication with the heat exchanger, wherein the heat exchanger is configured to regulate a temperature of the fluid.

19. A plate assembly, comprising:
a first end plate and a second end plate each configured to be positioned within a chamber and defining a longitudinal axis from the first end plate to the second end plate;
a plurality of plates positioned between the first end plate and the second end plate, configured to be submerged in a fluid within the chamber, and including:
a plurality of cathode plates,
a plurality of anode plates, and
a plurality of semi-permeable membrane plates positioned between the cathode plate and the anode plate and configured to allow the passage of some elements therethrough and to block the passage of other elements therethrough, the plurality of anode plates and the plurality of cathode plates being positioned in an alternating repeating pattern with one of the plurality of semi-permeable membrane plates being positioned between each anode plate and each cathode plate.

20. A system for generating hydrogen, the system comprising:
a chamber configured to receive a fluid;
a first end plate and a second end plate configured to be positioned within the chamber and defining a longitudinal axis from the first end plate to the second end plate;
a plurality of plates positioned between the first end plate and the second end plate, configured to be submerged in the fluid, and including:
a plurality of cathode plates,
a plurality of anode plates positioned in an alternating fashion with the plurality of cathode plates, and
a plurality of semi-permeable membrane plates each positioned between one of the cathode plates and one of the anode plates and configured to allow the passage of some elements therethrough and to block the passage of other elements therethrough, such that each plate is spaced apart from adjacent plates; and
at least one plasma source configured to be positioned within the fluid on an axial end of the plurality of plates and configured to generate a directed flow of plasma through the chamber along the axis.
